(19) United States
(12) Patent Application Publication
(10) Pub. No.: US 2018/0319926 A1
(43) Pub. Date: Nov. 8, 2018

(54) POLYURETHANE FOAM FOR NOISE AND VIBRATION ABSORPTION

(71) Applicant: DOW GLOBAL TECHNOLOGIES LLC, Midland, MI (US)

(72) Inventors: Sabrina Fregni, Nonantola (IT); Jun Cai, MIdland, MI (US); Selvaggia Landi, Carpi (IT)

(73) Assignee: DOW GLOBAL TECHNOLOGIES LLC, Midland, MI (US)

(21) Appl. No.: 15/772,544

(22) PCT Filed: Oct. 26, 2016
(86) PCT No.: PCT/US2016/058740

§ 371 Date: May 1, 2018

(30) Foreign Application Priority Data
Nov. 3, 2015 (IT) 102015000068490

(51) Int. Cl. C08G 18/76; C08G 18/66; C08G 18/32; C08G 18/42; C08J 9/00; C08J 9/12; C08K 3/04; G10K 11/162

(52) U.S. Cl. CPC C08G 18/7671; C08G 18/664; C08G 18/3218; C08G 18/4263; C08J 9/0066; C08G 2101/005; C08J 9/125; C08K 3/04; C08K 3/041; G10K 11/162; C08J 9/0076

(57) ABSTRACT

The present invention relates to a reactive formulation used to make a polyurethane foam which is particularly suited for use in under the hood vehicle applications which require sound deadening and vibration management and a process to make said foam. In particular, the polyurethane foam is made from a reactive formulation comprising an A side comprising (i) one or more organic isocyanate and a B side comprising (ii) one or more isocyanate-reactive component, (iii) a carbon nanofiller; and (iv) one or more additional component selected from a catalyst, a blowing agent, a cell opener, a surfactant, a crosslinker, a chain extender, a filler, a colorant, a pigment, an antistatic agent, reinforcing fibers, an antioxidant, a preservative, or an acid scavenger.

### FIELD OF THE INVENTION

The present invention relates to a composition for a polyurethane foam which is particularly suited for use in applications which require sound deadening and vibration management.

### BACKGROUND OF THE INVENTION

Noise and vibration management is a significant issue for vehicle manufacturers, as cabin noise is a major factor in the comfort experience of automotive passengers. Therefore, noise, vibration, and harshness (NVH) abatement measures are routinely incorporated into motor vehicles. These abatement measures are often polyurethane foams, which may also be called upon to perform some functional purpose such as seating, for example, or some aesthetic purpose. Seating may provide as much as 50 percent of the sound absorption in a vehicle and trim parts such as headliners and instrument panels absorb still more of the sound. These functional parts must have physical and other performance properties as required for their specific uses. Therefore, in most cases noise and vibration absorption cannot come at the expense of the physical properties of the foam.

There exists an unmet need for a polyurethane foam composition for sound deadening and vibration applications and method to make said foam, that is cost effective and does not require additional multiple process steps over conventional methods.

### BRIEF SUMMARY OF THE INVENTION

The present invention is such a polyurethane foam and process for preparing said foam.

In one embodiment, the present invention is a reactive formulation for making a polyurethane foam comprising, consisting essentially of, or consisting of a mixture of:

(A) an A side comprising, consisting essentially of, or consisting of
(i) one or more organic isocyanate, and

(B) a B side comprising, consisting essentially of, or consisting of:
(ii) one or more isocyanate-reactive component,
(iii) a carbon nanofiller having at least one dimension equal to or less than 100 nm, preferably the carbon nanofiller is carbon nanopowder, carbon nanoparticles, graphite nanoplatelets, graphene nanoplatelets, carbon nanofibers, carbon nanotubes, or mixtures thereof, and
(iv) one or more additional component selected from a catalyst, a blowing agent, a cell opener, a surfactant, a crosslinker, a chain extender, a flame retardant, a filler, a colorant, a pigment, an antistatic agent, reinforcing fibers, an antioxidant, a preservative, or an acid scavenger.

In a preferred embodiment of the present invention, the organic isocyanate of the reactive formulation disclosed herein above comprises monomeric MDI, polymeric MDI, combinations there of, and/or liquid variants thereof obtained by introducing uretonimine and/or carbodiimide groups forming polyisocyanates, said carbodiimide and/or uretonimine modified polyisocyanates having an NCO value of from 29 to 33 percent and included in said polyisocyanate is from 1 to 45 percent by weight of 2,4′-diphenylmethane diisocyanate in the form of a monomer and/or a carbodiimidization product thereof.

In another preferred embodiment of the present invention, the isocyanate-reactive component isocyanate of the reactive formulation disclosed herein above comprises an ethylene-oxide capped polyether polyol.

In one embodiment of the present invention, the nanofiller disclosed herein above is not modified by inclusion of an organic functional group on the nanofiller.

In another embodiment of the present invention, the nanofiller disclosed herein above is modified by inclusion of an organic functional group on the nanofiller.

Another embodiment of the present invention is a process to make a polyurethane foam by the steps of:
(I) forming:
   (A) an A side comprising, consisting essentially of, or consisting of
      (i) one or more organic isocyanate,
   and
   (B) a B side comprising, consisting essentially of, or consisting of:
      (ii) one or more isocyanate-reactive component,
      (iii) a carbon nanofiller having at least one dimension equal to or less than 100 nm, preferably the carbon nanofiller is carbon nanopowder, carbon nanoparticles, graphite nanoplatelets, graphene nanoplatelets, carbon nanofibers, carbon nanotubes, or mixtures thereof, and
      (iv) one or more additional component selected from a catalyst, a blowing agent, a cell opener, a surfactant, a crosslinker, a chain extender, a flame retardant, a filler, a colorant, a pigment, an antistatic agent, reinforcing fibers, an antioxidant, a preservative, or an acid scavenger;
(II) mixing the A side and the B side together to form a reactive formulation; and
(III) subjecting the resulting reactive formulation to conditions sufficient to cure the reactive formulation to form a polyurethane foam, preferably the foam is used in an automotive vehicle for acoustic insulation, preferably for insulation of an engine compartment, a fuel injector, an oil pan, an undercover, a hood silencer, a seat cushion, a bulkhead, a door, a roof, or a dashboard.

In a preferred embodiment of the reactive formulation and/or process described herein above, the polyurethane foam has a density of from 10 g/l to 40 g/l and an air flow resistance according to ISO 9053 equal to or less than 5,000 Ns/m³, preferably 1,500 Ns/m³.

### BRIEF DESCRIPTION OF THE DRAWINGS

FIG. 1 is a plot showing the acoustic absorption of an example of the invention versus a comparative example.

FIG. 2 is a plot showing the acoustic absorption of a second example of the invention versus a comparative example.

FIG. 3 is a plot showing the acoustic absorption of a third example of the invention versus a comparative example.

### DETAILED SUMMARY OF THE INVENTION

The present invention includes a polyurethane foam and a method of producing the polyurethane foam. The polyurethane foam is particularly suitable for vehicle applications requiring noise, vibration, and harshness (NVH) reduction, for example trim parts, headliners, instrument panels, under the hood applications, and the like. However, it is to be appreciated that the polyurethane foam of the present invention can have applications beyond vehicle applications.

A preferred polyurethane foam is a very low density, semi-rigid open cell foam. For example one having a density between 10 to 40 g/l, preferably 10 to 35 g/l, preferably 12 to 25 g/l and more preferably 12 to 15 g/l. The foam of the present invention preferably has an air flow resistance according to ISO 9053 equal to or less than 5,000 Ns/m³, preferably equal to or less than 1,500 Ns/m³.

The polyurethane foams according to the present invention are prepared from a reactive formulation comprising an A side comprising one or more organic isocyanate (i) and a B side comprising one or more isocyanate-reactive component (ii), a nanofiller component (iii), and optionally one or more additives (iv).

Suitable organic isocyanates (i) for use in the composition and process of the present invention include any of those known in the art for the preparation of polyurethane foams, like aliphatic, cycloaliphatic, araliphatic and, preferably, aromatic isocyanates, such as toluene diisocyanate in the form of its 2,4 and 2,6-isomers and mixtures thereof and diphenylmethane diisocyanate in the form of its 2,4′-, 2,2′- and 4,4′-isomers and mixtures thereof, the mixtures of diphenylmethane diisocyanates (MDI) and oligomers thereof having an isocyanate functionality greater than 2 known in the art as “crude” or polymeric MDI (polymethylene polyphenylene polyisocyanates), the known variants of MDI comprising urethane, allophanate, urea, biuret, carbodiimide, uretonimine and/or isocyanurate groups.

Preferably monomeric MDI, crude MDI, polymeric MDI, combinations thereof, and/or liquid variants thereof are obtained by introducing uretonimine and/or carbodiimide groups into said polyisocyanates, such a carbodiimide and/or uretonimine modified polyisocyanate having an NCO value of from 29 to 33 percent and includes 1 to 60 percent by weight of 2,4′-diphenylmethane diisocyanate in the form of a monomer and/or a carbodiimidization product thereof. Preferable MDI mixtures have from 25 to 60 percent by weight content of monomeric MDI, particularly preferably from 30 to 50 percent by weight content of monomeric MDI. For a good description of such carbodiimide and/or uretonimine modified polyisocyanates see U.S. Pat. No. 6,765,034, which is incorporated by reference herein in its entirety.

In the present invention, the organic isocyanate component may include one or more organic polyisocyanate, in addition to and/or in place of monomeric MDI as needed, provided other polyisocyanate compounds do not have adverse influences on the performance on the desired sound deadening and vibration management properties of the polyurethane foam. Typical examples of such other polyisocyanate compounds include isocyanate-terminal prepolymers which are formed by a reaction between at least one of compounds of the above-indicated monomeric MDI, and suitable active hydrogen compounds. To improve the formability and other characteristics of the obtained foam, the other polyisocyanate compounds may be selected from among organic isocyanates such as toluene diisocyanate (TDI), isopholone diisocyanate (IPDI) and xylene diisocyanates (XDI), and modifications thereof. These isocyanates may be used in combinations of two or more types. Most preferably polyisocyanates are used which have an average isocyanate functionality of 2.1 to 3.0 and preferably of 2.2 to 2.8.

The amount of polyisocyanate that is used to make foam typically is sufficient to provide an isocyanate index of from 0.6 to 1.5, preferable 0.6 to 1.2, although wider ranges can be used in special cases. A preferred range is from 0.7 to 1.05 and a more preferred range is from 0.75 to 1.05.

The B side of the present invention comprises an isocyanate-reactive component (ii) which includes any type of compound of those known in the art for that purpose, for example polyamines, aminoalcohols and polyols.

Suitable polyols have been fully described in the prior art and include reaction products of alkylene oxides, for example ethylene oxide and/or propylene oxide, with initiators containing from 2 to 8 active hydrogen atoms per molecule. Suitable initiators include: polyols, for example ethylene glycol, diethylene glycol, propylene glycol, dipropylene glycol, butane diol, glycerol, trimethylolpropane, triethanolamine, pentaerythritol, sorbitol and sucrose; polyamines, for example ethylene diamine, tolylene diamine, diaminodiphenylmethane and polymethylene polyphenylene polyamines; and aminoalcohols, for example ethanolamine and diethanolamine; and mixtures of such initiators. Other suitable polyols include polyesters obtained by the condensation of appropriate proportions of glycols and higher functionality polyols with polycarboxylic acids. Still further suitable polyols include hydroxyl terminated polythioethers, polyamides, polyesteramides, polycarbonates, polyacetals, polyolefins and polysiloxanes. Still further suitable isocyanate-reactive components include ethylene glycol, diethylene glycol, propylene glycol, dipropylene glycol, butane diol, glycerol, trimethylolpropane, ethylene diamine, ethanolamine, diethanolamine, triethanolamine and the other initiators mentioned before. Mixtures of such isocyanate-reactive components may be used as well. Most preferably polyols are used which do not comprise primary, secondary or tertiary nitrogen atoms.

Suitable polyols and polyol mixtures for the preparation of the polyurethane foams of the present invention are have average molecular weights of 200 to 15,000, preferably 4,000 to 8,000. The polyols and polyol mixtures for use in the present invention preferably have hydroxyl numbers of 20 to 700. Of particular importance for the preparation of the polyurethane foams of the present invention are polyols and polyol mixtures having hydroxyl equivalent weight of equal to or greater than 1200, preferably equal to or greater s than 1500, more preferably equal to or greater than 1700. Polyol equivalent weight is the molecular weight of the polyol divided by the hydroxyl functionality of the molecule. Of particular importance for the preparation of the polyurethane foams of the present invention are polyols and polyol mixtures having hydroxyl equivalent weight of equal to or less than 4000, preferably equal to or less than 3000 and more preferably equal to or less than 2500. Polyols used for the preparation of the foams of the present invention have an average nominal hydroxyl functionality of from 2 to 8, preferably of from 3 to 5.

Of particular importance for the preparation of the foams are reaction products of alkylene oxides, for example ethylene oxide and/or propylene oxide, with initiators containing from 2 to 8 active hydrogen atoms per molecule. Suitable initiators include: polyols, for example ethylene glycol, diethylene glycol, propylene glycol, dipropylene glycol, butane diol, glycerol, trimethylolpropane, triethanolamine, pentaerythritol and sorbitol; polyamines, for example ethylene diamine, tolylene diamine, diaminodiphenylmethane and polymethylene polyphenylene polyamines; and aminoalcohols, for example ethanolamine and diethanolamine; and mixtures of such initiators. Other suitable polyols include polyesters obtained by the condensation of appropriate proportions of glycols and higher functionality polyols with polycarboxylic acids. Still further suitable polyols include hydroxyl terminated polythioethers, polyamides, polyesteramides, polycarbonates, polyacetals, polyolefins and polysiloxanes. Preferred polyols are the polyether polyols comprising ethylene oxide and/or propylene oxide units and most preferably polyoxyethylene polyoxypropylene polyols having an oxyethylene content of at least 10 percent and preferably 10 to 85 percent by weight. A preferred isocyanate-reactive component comprises an ethylene-oxide capped polyether polyol.

Other polyols which may be used comprise dispersions or solutions of addition or condensation polymers in polyols of the types described above. Such modified polyols, often referred to as “copolymer” polyols have been fully described in the prior art and include products obtained by the in situ polymerisation of one or more vinyl monomers, for example styrene and acrylonitrile, in polymeric polyols, for example polyether polyols, or by the in situ reaction between a polyisocyanate and an amino- or hydroxy-functional compound, such as triethanolamine, in a polymeric polyol.

The polymer modified polyols which are particularly interesting in accordance with the invention are products obtained by in situ polymerisation of styrene and/or acrylonitrile in polyoxyethylene polyoxypropylene polyols and products obtained by in situ reaction between a polyisocyanate and an amino or hydroxy-functional compound (such as triethanolamine) in a polyoxyethylene polyoxypropylene polyol.

Polyoxyalkylene polyols containing from 5 to 50 percent of dispersed polymer are particularly useful. Particle sizes of the dispersed polymer of less than 50 microns are preferred. Mixtures of such isocyanate-reactive components may be used as well. Most preferably polyols are used which do not comprise primary, secondary or tertiary nitrogen atoms.

The B side further comprises a nanofiller component (iii) which comprises one or more of nanoparticles, nanotubes, nanopowders, nanofibers, or mixtures thereof.

The nanofiller component is dispersed in the one or more isocyanate-reactive component of the B side. In some embodiments, the nanofiller is dispersed in the polyol. Preferably, the nanofillers, as described herein, are substantially uniformly dispersed in the polyol. Substantially uniform dispersion within the polyol may improve the ability of polyurethane foam made therefrom to absorb sounds and vibrations. In some embodiments, the nanofillers may be physically dispersed using sonication. In other embodiments, the nanofillers may be physically dispersed using a mechanical device. For example, the nanofillers may be dispersed in the polyol using a mixer, a blender, sonication, or combinations thereof to achieve a substantially uniform dispersion.

In some embodiments, the nanofillers may be one or more selected from nanopowders, nanotubes, nanofibers, and/or nanoparticles. Some nanopowders include, but are not limited to, aluminum nitride, carbon, silicon, magnesium hydroxide, silicon carbide, silicon nitride, or titanium carbide. In some embodiments, oxide nanopowders may also be used. Such oxide nanopowders include, but are not limited to, one or more selected from aluminum oxide, silica, and titanium oxide.

Nanotubes may be based on carbon and/or other elements. In some embodiments, the nanotubes are cylindrical and comprise a hexagonal lattice of carbon and/or other elements. In some embodiments, the nanotubes are metallic and/or semiconductive. In some embodiments, the nanotubes exhibit a high tensile strength. In one embodiment, single walled nanotubes may be used. In other embodiments, multi-walled carbon nanotubes are used.

Nanofillers may also include metal or metal oxide nanoparticles. In some embodiments, the metal or metal oxide nanoparticles are colloidal. Some exemplary nanoparticles include silicon dioxide (SiO₂), aluminum oxide (Al₂O₃), titanium dioxide (TiO₂), tin oxide (SnO₂), iron oxide (Fe₂O₃), zinc oxide (ZnO), magnesium oxide (MgO), zirconium oxide (ZrO₂), cerium oxide (CeO₂), lithium oxide (Li₂O), and silver oxide (AgO). The colloidal metal (oxide) nanoparticles may also include, but are not limited to, one or more metals such as silver (Ag), nickel (Ni), magnesium (Mg), and zinc (Zn). In some embodiments, one or more metal and/or metal oxides nanoparticles are used in combination. In some embodiments, mixed metal oxide nanoparticles may also be used.

In some embodiments, one or more metal alloy nanoparticles may be used. Such nanoparticles include a metal alloy nanoparticle comprising one or more metals selected from aluminum (Al), copper (Cu), gold (Au), iron (Fe), nickel (Ni), platinum (Pt), silver (Ag), tantalum (Ta), tin (Sn), titanium (Ti), and zinc (Zn).

Other nanofillers include a nanoclay material called montmorillonite, which is a layered smectite clay. Clays may also be modified to be more “organic” to interact successfully with the polyol. One way to modify clay is by exchanging organic ammonium cations for inorganic cations from the clay's surface.

Additional nanofillers include graphite platelets, graphene platelets, carbon nanofibers, synthetic clays, natural fibers (hemp or flax), barium sulfate, and polyhedral oligomeric silsesquioxane (POSS).

In one embodiment of the present invention, the nanofiller is a carbon nanofiller, preferably carbon nanopowder, carbon nanoparticles, graphite nanoplatelets, graphene nanoplatelets, carbon nanofibers, carbon nanotubes, or mixtures thereof.

In some embodiments, the nanofillers are modified. In some embodiments, the nanoparticles are modified by inclusion of an organic functional group on the nanofiller. In some embodiments, a benzyl group is a used as an organic functional group. Other organic functional groups include hydroxyl, acetyl, phenyl, alkyloxy, alkyl (e.g., methyl, ethyl, propyl, and substituted alkyls). In another embodiment, inorganic salts may be added to the composite to change the hydrophobicity of the composite. In some embodiments, the nanotubes are modified with NaOH. In some embodiments, the modification of the nanofillers provides a more hydrophobic composite material. Additionally, such modification may result in substantially more uniform dispersion of the nanofiller within the polyol than compared to the nanofiller without the modification. In some embodiments, the metal (oxide) nanoparticles are modified to increase the interaction of the polyol and nanoparticles. In one embodiment, the nanofillers comprised in the polyurethane foams of the present invention are modified. However, the polyurethane foams as disclosed herein are not limited to modified nanofiller materials. In one embodiment, the nanofillers comprised in the polyurethane foams of the present invention are not modified.

Nanofillers described herein may be used in various sizes and shapes. In some embodiments, the nanofillers have an average size wherein at least one dimension is from about 1 nm to about 1,000 nm. In some embodiments, the nanofillers have an average size wherein at least one dimension is of 10 nm to 100 nm. In some embodiments, the nanofillers have an average size wherein at least one dimension is of 30 nm to 300 nm. In additional embodiments, the nanofillers have an average size wherein at least one dimension is of 1 nm to 50 nm. In one exemplary embodiment, the nanoparticles have an average size wherein at least one dimension is 100 nm. In some embodiments, the nanoparticles may have different average sizes, such as a bimodal or trimodal particle size distribution.

The nanofiller (iii) is present in an amount of equal to or greater than 0.05 weight percent based on the total weight of the B side, preferably equal to or greater than 0.1 weight percent, and more preferably equal to or greater than 0.2 weight percent based on the total weight of the B side. The nanofiller (iii) is present in an amount of equal to or less than 20 weight percent based on the total weight of the B side, preferably equal to or less than 10 weight percent, and more preferably equal to or less than 5 weight percent based on the total weight of the B side.

The reaction of the reactive formulation of the present invention comprising one or more organic polyisocyanate (i), one or more isocyanate-reactive component (ii), and the nanofiller component (iii), to make a polyurethane foam can be performed in the presence of various types of other additional materials (iv), as may be useful in the particular manufacturing process that is used or to impart desired characteristics to the resulting foam. These include, for example, catalysts, blowing agents, cell openers, surfactants, crosslinkers, chain extenders, flame retardants (such as ammonium polyphosphate, red phosphorous, expandable graphite, antimony oxide, sodium citrate, an organic and/or inorganic compound, a boron-containing compound, a halogenated and/or non-halogenated compound, or mixtures thereof), fillers, colorants, pigments, antistatic agents, reinforcing fibers, antioxidants, preservatives, acid scavengers, and the like.

The B side may comprise one or more additional components (iv). For example, in order to prepare a polyurethane foam of the present invention a blowing agent is required, preferably water. However if the amount of water is not sufficient to obtain the desired density of the foam any other known way to prepare polyurethane foams may be employed additionally, like the use of reduced or variable pressure, the use of a gas like air, N₂ and CO₂, the use of more conventional blowing agents like chlorofluorocarbons, hydrofluorocarbons, hydrocarbons and fluorocarbons, the use of other reactive blowing agents, i.e. agents which react with any of the ingredients in the reacting mixture and due to this reaction liberate a gas which causes the mixture to foam and the use of catalysts which enhance a reaction which leads to gas formation like the use of carbodiimide-formation-enhancing catalysts such as phospholene oxides. Combinations of these ways to make foams may be used as well. The amount of blowing agent may vary widely and primarily depends on the desired density. Water is typically added in an amount of 1 to 18 weight percent, preferably 1 to 15 weight percent based on the weight of the polyol.

One embodiment of the present invention is a combination of blowing agent is water and CO₂ wherein the CO₂ is added to the ingredients for making the foam in the mixing head of a device for making the foam, to one of the isocyanate-reactive ingredients and preferably to the polyisocyanate before the polyisocyanate is brought into contact with the isocyanate-reactive ingredients.

In one embodiment, the polyurethane foam of the present invention is made from reactive formulations comprising (A) the A side comprising an organic isocyanate (i) and (B) the B side comprising an isocyanate-reactive component (ii), and the nanofiller component (iii) in the presence of water. Preferably, such formulations contain from 1 to 18 weight percent, especially from 10 to 15 weight percent water based on the total weight of the isocyanate-reactive component (ii). Desirable polyurethane foam can be made in a slabstock process or in a closed mold. Closed mold molding processes are preferred to make shaped products such as under the hood applications, for example, engine encapsulation members.

As an additional component (iv), one or more catalyst may be present in the B side of the reactive formulation of the present invention. Suitable catalysts may be primary amine catalysts, secondary amine catalysts, tertiary amine catalysts, or mixtures thereof. The tertiary amine catalyst may be any compound possessing catalytic activity for the reaction between a polyol and an organic polyisocyanate and at least one tertiary amine group. Representative tertiary amine catalysts include trimethylamine, triethylamine, dimethylethanolamine, N-methylmorpholine, N-ethyl-morpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl) ether, morpholine, 4,4′-(oxydi-2,1-ethanediyl)bis, triethylenediamine, pentamethyl diethylene triamine, dimethyl cyclohexyl amine, N-acetyl N,N-dimethyl amine, N-coco-morpholine, N,N-dimethyl aminomethyl N-methyl ethanol amine, N, N, N′-trimethyl-N′-hydroxyethyl bis(aminoethyl) ether, N,N-bis(3-dimethylaminopropyl)N-isopropanolamine, (N,N-dimethyl) amino-ethoxy ethanol, N, N, N′, N′-tetramethyl hexane diamine, 1,8-diazabicyclo-5,4,0-undecene-7, N,N-dimorpholinodiethyl ether, N-methyl imidazole, dimethyl aminopropyl dipropanolamine, bis(dimethylaminopropyl)amino-2-propanol, tetramethylamino bis (propylamine), (dimethyl(aminoethoxyethyl))((dimethyl amine)ethyl)ether, tris(dimethyl-amino propyl) amine, dicyclohexyl methyl amine, bis(N,N-dimethyl-3-aminopropyl) amine, 1,2-ethylene piperidine and methyl-hydroxyethyl piperazine

The B side of the reactive formulation may contain one or more other catalysts, in addition to or instead of the tertiary amine catalyst mentioned before. Of particular interest among these are tin carboxylates and tetravalent tin compounds. Examples of these include stannous octoate, dibutyl tin diacetate, dibutyl tin dilaurate, dibutyl tin dimercaptide, dialkyl tin dialkylmercapto acids, dibutyl tin oxide, dimethyl tin dimercaptide, dimethyl tin diisooctylmercaptoacetate, and the like.

Catalysts are typically used in small amounts. For example, the total amount of catalyst used may be 0.0015 to 5 weight percent, preferably from 0.01 to 1 weight percent based on the total weight of the isocyanate-reactive compound (ii). Organometallic catalysts are typically used in amounts towards the low end of these ranges.

The B side may further comprise as one of the additional components (iv) a crosslinker, which preferably is used, if at all, in small amounts, to 2 weight percent, up to 0.75 weight percent, or up to 0.5 weight percent based on the total weight of the isocyanate-reactive compound (ii). The crosslinker contains at least three isocyanate-reactive groups per molecule and has an equivalent weight, per isocyanate-reactive group, of from 30 to about 125 and preferably from 30 to 75 Aminoalcohols such as monoethanolamine, diethanolamine and triethanolamine are preferred types, although compounds such as glycerine, trimethylolpropane and pentaerythritol also can be used.

The B side may further comprise a surfactant as an additional component (iv). A surfactant is preferably included in the foam formulation to help stabilize the foam as it expands and cures. Examples of surfactants include nonionic surfactants and wetting agents such as those prepared by the sequential addition of propylene oxide and then ethylene oxide to propylene glycol, solid or liquid organosilicones, and polyethylene glycol ethers of long chain alcohols. Ionic surfactants such as tertiary amine or alkanolamine salts of long chain alkyl acid sulfate esters, alkyl sulfonic esters and alkyl arylsulfonic acids can also be used. The surfactants prepared by the sequential addition of propylene oxide and then ethylene oxide to propylene glycol are preferred, as are the solid or liquid organosilicones. Examples of useful organosilicone surfactants include commercially available polysiloxane/polyether copolymers such as TEGOSTAB™ B-8729, and B-8719LF available from Goldschmidt Chemical Corp., and NIAX™ L2171 surfactant from Momentive Performance Materials. Non-hydrolyzable liquid organosilicones are more preferred. When a surfactant is used, it is typically present in an amount of 0.0015 to 1 weight percent based on the total weight of the organic isocyanate (i).

A cell opener may be present as an additional component (iv) in the B side of the reactive formulation. The cell opener functions during the polymerization reaction to break cell walls and therefore promote the formation of an open cell structure. A high open cell content (at least 25 percent by number, preferably at least 50 percent) is usually beneficial for foams that are used in noise and vibration absorption applications. A useful type of cell opener includes ethylene oxide homopolymers or random copolymers of ethylene oxide and a minor proportion of propylene oxide, which have a molecular weight of 5000 or more. These cell openers preferably have a hydroxyl functionality of at least 4, more preferably at least 6. Cell openers are preferably used in amounts from about 0.5 to about 5 weight percent based on the total weight of the isocyanate-reactive compound (ii).

A chain extender may be employed as an additional component (iv) in the B side of the reactive formulation of the present invention. A chain extender is a compound having exactly two isocyanate-reactive groups and an equivalent weight per isocyanate-reactive group of up to 499, preferably up to 250, also may be present. Chain extenders, if present at all, are usually used in small amounts, such as up to 10, preferably up to 5 and more preferably up to 2 weight percent based on the total weight of the isocyanate-reactive compound (ii). Examples of suitable chain extenders include ethylene glycol, diethylene glycol, triethylene glycol, propylene glycol, dipropylene glycol, tripropylene glycol, 1,4-dimethylolcyclohexane, 1,4-butane diol, 1,6-hexane diol, 1,3-propane diol, diethyltoluene diamine, amine-terminated polyethers such as JEFFAMINE™ D-400 from Huntsman Chemical Company, amino ethyl piperazine, 2-methyl piperazine, 1,5-diamino-3-methyl-pentane, isophorone diamine, ethylene diamine, hexane diamine, hydrazine, piperazine, mixtures thereof and the like.

The B side may also comprise as an additional component (iv) a filler, which reduces overall cost, load bearing and other physical properties to the product. The filler may constitute up to about 50 percent, of the total weight of the polyurethane reactive formulation (i.e., the combined weight of the organic isocyanate (i), the isocyanate-reactive compound (ii), and the nanofiller component (iii)). Suitable fillers include talc, mica, montmorillonite, marble, barium sulfate (barytes), milled glass granite, milled glass, calcium carbonate, aluminum trihydrate, carbon, aramid, silica, silica-alumina, zirconia, talc, bentonite, antimony trioxide, kaolin, coal based fly ash and boron nitride.

Foam can be made in accordance with the invention in a slabstock process or in a closed mold molding process. Slabstock foam is formed as a large bun which is cut into the required shape and size for use. Closed mold molding processes can be either so-called hot molding process or a cold molding process wherein the foaming takes place in a closed mold. After the foam has cured, the mold is opened, and the foam removed. An integral skin can be formed onto the surface of the foam in the mold. A film, fabric, leather or other coverstock can be inserted into the mold prior to introducing the reactive formulation, to produce a foam that has a desirable show surface.

Polyurethane foam formulations that contain a mixture of ethylene oxide-capped polypropylene oxides in accordance with the invention have been found to process well, especially in formulations in which water is used as a blowing agent, especially when used as the sole blowing agent as described herein above. Good processing herein refers to the ability of a foam formulation to consistently produce good quality foam in an industrial setting. Good processing is indicated by consistently uniform cell structure, complete mold filling, consistently good surface appearance, consistent foam density and consistency in foam physical properties as the foam is produced over time. The foam formulation tolerates small changes in operating temperatures, catalyst levels and other process conditions which often cause significant product inconsistencies in other high water foam formulations.

In one embodiment, the foam is crushed to open the cells. A high open cell content (at least 25 percent by number, preferably at least 50 percent) may be beneficial for foams that are used in noise and vibration absorption applications.

The polyurethane foam of the present invention advantageously also has a density in the range of 12 to 160 g/l, preferably from 12 to 40 g/l, more preferably 12 to 20 g/l, even more preferably 12 to 15 g/l. Density is conveniently measured according to ASTM D 3574.

To manufacture the polyurethane foam of the present invention, a reactive formulation is prepared, said reactive formulation comprising: an A side comprising (i) one or more organic polyisocyanate and a B side comprising (ii) one or more isocyanate-reactive component, (iii) a nanofiller; and (iv) one or more additional component selected from a catalyst, a blowing agent, a cell opener, a surfactant, a crosslinker, a chain extender, a flame retardant (other than red phosphorus, expandable graphite, and sodium citrate), a filler, a colorant, a pigment, an antistatic agent, reinforcing fibers, an antioxidant, a preservative, or an acid scavenger. The “B side”, is a premix comprising the appropriate amounts of polyol, nanofiller component, blowing agent, catalyst, foaming aid, and other aids specific to the desired polyol component/final foam. Depending on the composition of the B side, elevated temperatures, above 40° C., may be required to mix the components. Preferably, the B side is mixed together at a temperature less than 40° C., more preferably it is mixed together at ambient temperature (defined herein as from 20° C. to 30° C.). The B side is then mixed with the specific organic (poly)isocyanate component, comprised in the “A side” at the desired ratio, forming the reactive formulation which, when mixed, allows for the foaming reaction to occur. The polyol premix (B side) and the organic polyisocyanate component (A side) are mixed together by any known urethane foaming equipment. The resulting reactive formulation is subjected to conditions sufficient to cure the reactive formulation to form a sound and/or vibration-absorbing polyurethane foam. The reactive formulation is either introduced into a suitable mold, so that a foaming/curing reaction takes place within the mold to form the desired polyurethane foam or it is allowed to foam/cure to form a slab stock or it is foamed in place.

The sound and/or vibration-absorbing polyurethane foam thus manufactured can be suitably used for noise and vibration-absorbing applications according to the present invention, for example, for an automotive vehicle for acoustic insulation of an engine compartment, a fuel injector, an oil pan, an under cover, a hood silencer, a seat cushion, a bulkhead, a door, a roof, or a dashboard. Further, the foams may be used for and/or molded into an article to be used for and/or molded/foamed in place as an engine cover, an engine s noise insulator, a fuel injector encapsulant, a side cover, an oil pan cover, an under cover, a hood silencer, and a dashboard silencer, to reduce the amount of sound or noise transmitted within the passenger compartment of the vehicle. In particular, the sound and/or vibration-absorbing polyurethane foam may be suitably used and/or molded into articles to be used for or molded/foamed in place as spacers or fillers for filling gaps or spaces between the engine and the surrounding devices, or encapsulation of engine parts for attenuating the standing waves, noise radiation from the engine block, noise radiation from the gearbox, noise radiation from the differential, noise radiation from the exhaust system, noise radiation from the radiator fan, noise radiation from the silencer, and tire noise.

One embodiment of the present invention is a sound and/or vibration-absorbing polyurethane foam for under the hood noise and vibration-absorbing applications having a density of 12 to 15 g/l.

Another embodiment of the present invention is a sound and/or vibration-absorbing polyurethane foam for headliner noise and vibration-absorbing applications having a density of 20 to 35 g/l.

### Examples

Comparative Example A and Examples 1 to 3 comprise a reaction formulation used to provide a polyurethane foam comprising a polyol component and other additives (B side) and an isocyanate component (A side). The polyol component comprises one or more polyol, catalyst, optional a carbon nanofiller, blowing agent (water), silicon surfactant, cell opener, and black colorant wherein the components are pre mixed. All foam formulations are processed by free rise polymerizations, dispensing the polyurethane foam mixture directly by hand-mixing. Isocyanate, polyols (polyol formulations prepared using the recipes reported in Table 1) and additives (catalyst) are conditioned at 25° C., weighted in a 1 liter PE cup, stirred for a maximum of 10 seconds using of a mechanical overhead stirrer (Heidolph mixer at 3000 rpm) then poured into a wooden polymerization box (internal dimension 200×300×250 mm).

For Comparative Example A and Examples 1 to 3 a formulated polyol blend (comprising polyols and other additives) is made from the following components. Amounts are given as parts by weight based on the total weight of the formulated polyol blend. The amounts for the components making up the polyol component (B) are given in parts by weight based on the total weight of the polyol component (B). The ratio of the polyol component (B) and the isocyanate component (A) are also given parts.

The composition of the polyol component (B side) for Comparative Example A and each Examples 1 to 3 are listed in Table 1. In Table 1:

“Polyol-1” is a glycerin initiated propylene oxide polyol, nominal having a hydroxyl number 660 and an equivalent weight of 85 available as VORANOL™ CP 260 Polyol from The Dow Chemical Company;

“Polyol-2” is a glycerine initiated propylene oxide and 15 percent ethylene oxide capped polyol having a hydroxyl number of 27.5 and an equivalent weight of 2040 available as VORANOL CP 6001 Polyol from The Dow Chemical Company;

“Polyol-3” is a glycerine initiated mixed feed propylene oxide and ethylene oxide polyol having a hydroxyl number of 33 and an equivalent weight of 1675 available as VORANOL CP 1421 Polyol from The Dow Chemical Company;

“Polyol-4” is a diethylene glycol-phthalic anhydride-based polyester polyol having a hydroxyl number of 300 to 330 and an equivalent weight of 175 available as STEPANPOL™ PS 3152 from Stephan Company;

“Cell Opener” is a formulation comprising organic polymers used as a cell opener available as ORTEGOL™ 501 from Evonik Industries;

“Surfactant” is a silicon surfactant available as TEGOSTAB™ B 8863 Z from Evonic Industries; “G2Nan” is graphite nanoplatelet particles obtained by exfoliation of expanded graphite having an average flake thickness of 10 nm and an average lateral particle size of 5-50 μm, available from Punto Quantico a spin-off of Composite Material Biomaterial CNR;

“GNP” is coarse graphite nanoplatelets having an average flake thickness of 15 nm average lateral particle size of 25-50 μm available from Punto Quantico a spin-off of Composite Material Biomaterial CNR;

“CNT” is carbon nanotubes having an average diameter of 9.5 nm and an average length of 1.5 μm available as NANOCYL™ NC 7000 from Nanocyl S. A;

“Catalyst” is an organotin based catalyst and cross-linker available as NK 932 Catalyst from The Dow Chemical Company;

“Black” is a black paste additive available as Black Repitan/IN 99546 from D. B. Becker Company;

and

“Isocyanate” is an MDI blend with 45 weight percent 4,4′-MDI, 18 weight percent 2,4′-MDI, and 35 weight percent polymeric MDI with an isocyanate content of about 32.1 available as SPECFLEX™ NE 449 from The Dow Chemical Company.

Reactivity profiles for the resultant foams from the formulated polyol mixtures of Comparative Examples A and Examples 1 to 3 are provided in Table 1. In Table 1:

“Isocyanate Index” is the ratio of the actual amount of isocyanate relative to the theoretical amount of isocyanate required to react with the polyol component and

“Density” is determined according to ASTM D3574 and is reported in grams per liter.

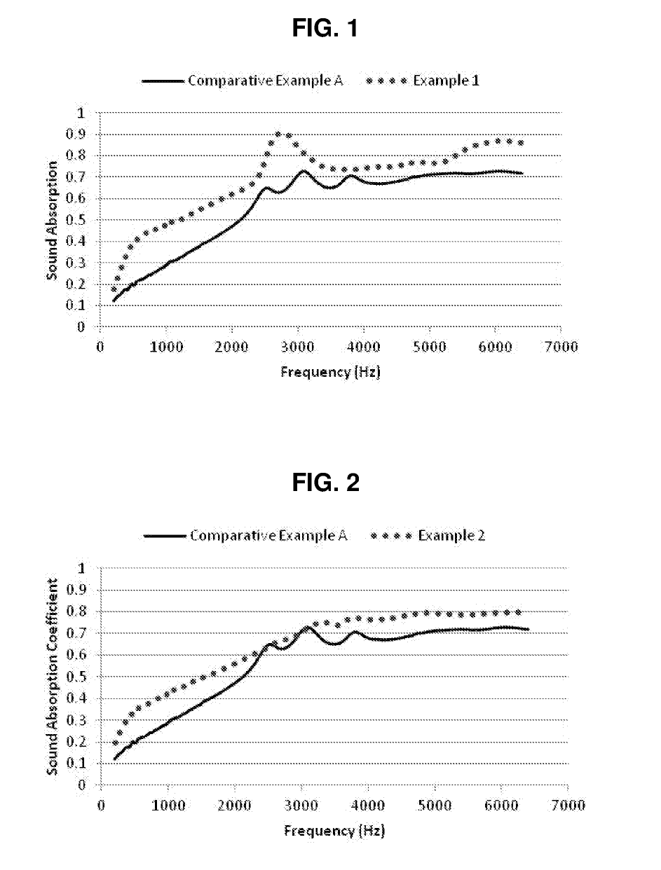

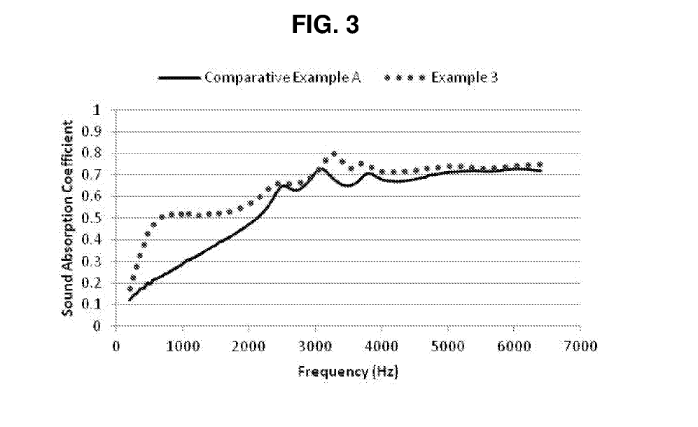

Normal incidence sound absorption coefficient is measured for the foam samples according to the ASTM E1050 standard. The samples are placed into the end of a Bruel & Kjaer 4206 29-mm diameter impedance tube with rigid backing plate sealed at the end to measure sound frequency range of 500-6400 Hz. A loudspeaker at the opposite end of the tube is used to generate planar sound waves that travel down the tube. A white noise signal is fed into the loudspeaker to generate noise over a broad frequency range. To perform the measurements, two microphones are used to measure the sound pressure level at known locations along the tube's length. A Bruel & Kjaer 3560 spectrum analyzer system is used to measure the sound pressure level signals from each microphone and used to compute the normal incidence sound absorption coefficient. The system collects 100 measurements and averages the results together to eliminate variability. The acoustic performance for Examples 1 to 3 versus Comparative Example A are illustrated in FIGS. 1 to 3, respectively. The acoustic absorption coefficient increased gradually when the sound frequency increased, which is a characteristic behavior of open cell foams.

TABLE 1

| | Example | | | |
|---|---|---|---|---|
| Comparative Example | A | 1 | 2 | 3 |
| POLYOL COMPONENT | | | | |
| (B side) | | | | |
| Polyol-1 | 5.6 | 5.6 | | |
| Polyol-2 | 59.5 | | | |
| 1 wt % CNT in Polyol-2 | | | | 59.5 |
| 2 wt % G2Nan in Polyol-2 | | | 59.5 | |
| 2 wt % GNP in Polyol-2 | | 59.5 | | |
| Polyol-3 | 10 | 10 | 10 | 10 |
| Polyol-4 | 10 | 10 | 10 | 10 |
| Surfactant | 0.4 | 0.4 | 0.4 | 0.4 |
| Cell Opener | 1.5 | 1.5 | 1.5 | 1.5 |
| Catalyst | 8.5 | 8.5 | 8.5 | 8.5 |
| Black | 3 | 3 | 3 | 3 |
| Water | 10 | 10 | 10 | 10 |
| TOTAL | 108.5 | 108.5 | 108.5 | 108.5 |
| ISOCYANATE | | | | |
| COMPONENT (A side) | | | | |
| Isocyanate | 100 | 100 | 100 | 100 |
| RATIO B side: A side | 0.54 | 0.54 | 0.54 | 0.54 |
| B side, parts | 108.5 | 108.5 | 108.5 | 108.5 |
| A side, parts | 199.4 | 199.4 | 199.4 | 199.4 |
| Isocyanate index | 105 | 105 | 105 | 105 |
| REACTIVITY | | | | |
| Avg. Cream Time, sec | 24 | 21 | 26 | 23 |
| Avg. Gel Time, Sec | 86 | 82 | 105 | 86 |
| Avg. Full Rise Time, sec | 120 | 110 | 120 | 110 |
| Avg. Density, g/L | 19.1 | 17.8 | 17.1 | 19 |

What is claimed is:

1. A reactive formulation for making a polyurethane foam comprising a mixture of:
(A) an A side comprising
(i) one or more organic isocyanate,
and
(B) a B side comprising:
(ii) one or more isocyanate-reactive component,
(iii) a carbon nanofiller having at least one dimension equal to or less than 100 nm,
and
(iv) one or more additional component selected from a catalyst, a blowing agent, a cell opener, a surfactant, a crosslinker, a chain extender, a flame retardant, a filler, a colorant, a pigment, an antistatic agent, reinforcing fibers, an antioxidant, a preservative, or an acid scavenger.

2. The reactive formulation of claim 1 wherein the organic isocyanate comprises monomeric MDI, polymeric MDI, combinations there of, and/or liquid variants thereof obtained by introducing uretonimine and/or carbodiimide groups forming polyisocyanates, said carbodiimide and/or uretonimine modified polyisocyanates having an NCO value of from 29 to 33 percent and included in said polyisocyanate is from 1 to 60 percent by weight of 2,4′-diphenylmethane diisocyanate in the form of a monomer and/or a carbodiimidization product thereof.

3. The reactive formulation of claim 1 wherein said isocyanate-reactive component comprises an ethylene-oxide capped polyether polyol.

4. The reactive formulation of claim 1 wherein the carbon nanofiller is carbon nanopowder, carbon nanoparticles, graphite nanoplatelets, graphene nanoplatelets, carbon nanofibers, carbon nanotubes, or mixtures thereof.

5. The composition of claim 1 wherein the nanofiller is not modified by inclusion of an organic functional group on the nanofiller.

6. The composition of claim 1 wherein the nanofiller is modified by inclusion of an organic functional group on the nanofiller.

7. A process to make a polyurethane foam by the steps of:
(I) forming:
(A) an A side comprising:
(i) one or more organic isocyanate,
and
(B) a B side comprising:
(ii) one or more isocyanate-reactive component,
(iii) a carbon nanofiller having at least one dimension equal to or less than 100 nm,
and
(iv) one or more additional component selected from a catalyst, a blowing agent, a cell opener, a surfactant, a crosslinker, a chain extender, a flame retardant, a filler, a colorant, a pigment, an antistatic agent, reinforcing fibers, an antioxidant, a preservative, or an acid scavenger;
(II) mixing the A side and the B side together to form a reactive formulation;
and
(III) subjecting the resulting reactive formulation to conditions sufficient to cure the reactive formulation to form a polyurethane foam.

8. The process of claim 7 wherein the carbon nanofiller is carbon nanopowder, carbon nanoparticles, graphite nanoplatelets, graphene nanoplatelets, carbon nanofibers, carbon nanotubes, or mixtures thereof.

9. The process of claim 7 wherein the polyurethane foam has a density of from 10 g/l to 40 g/l.

10. The use of the polyurethane foam of claim 1 in an automotive vehicle for acoustic insulation of an engine compartment, a fuel injector, an oil pan, an under cover, a hood silencer, a seat cushion, a bulkhead, a door, a roof, or a dashboard.
